(19) United States
(12) Patent Application Publication
(10) Pub. No.: US 2007/0218339 A1
(43) Pub. Date: Sep. 20, 2007

(54) LEAK-PROOF LIQUID FUEL CELL

(75) Inventors: Igor Derzy, Petah Tikva (IL); Gennadi Finkelshtain, Shoham (IL); Yuri Katsman, Hadera (IL); Mark Kinkelaar, Glenmoore, PA (US); Michael Lerner, Kiddush-Ha-Shem (IL); Leonid Sklyarsky, Rehovot (IL)

Correspondence Address: GREENBLUM & BERNSTEIN, P.L.C., 1950 ROLAND CLARKE PLACE, RESTON, VA, 20191, US

(73) Assignee: MORE ENERGY LTD., Lod (IL)

(21) Appl. No.: 11/684,497

(22) Filed: Mar. 9, 2007

Related U.S. Application Data
(60) Provisional application No. 60/781,732, filed on Mar. 14, 2006.

(51) Int. Cl. H01M 2/08; H01M 8/08

(52) U.S. Cl. 429/35; 429/46

(57) ABSTRACT

Described is a leak-proof fuel cell which comprises at least one liquid within a casing that comprises at least one opening which is sealed by a first structure that is gas-pervious and substantially impervious to the at least one liquid. At least that portion of the casing which comprises the at least one opening is enclosed by a second structure which allows gas to pass therethrough. A space defined by the casing and the second structure comprising therein at least one material that is capable of binding the at least one liquid. This Abstract is neither intended to define the invention disclosed in this specification nor intended to limit the scope of the invention in any way.

### CROSS-REFERENCE TO RELATED APPLICATIONS

The present application claims priority under 35 U.S.C. § 119(e) of U.S. Provisional Application No. 60/781,732, filed Mar. 14, 2006, the entire disclosure whereof is expressly incorporated by reference herein.

### BACKGROUND OF THE INVENTION

1. Field of the Invention

The present invention relates to a leak-proof liquid fuel cell, in particular, a portable liquid fuel cell, and to method of leak-proofing a liquid fuel cell.

2. Discussion of Background Information

Fuel cells are electrochemical power sources wherein electrocatalytic oxidation of a fuel at an anode and electrocatalytic reduction of an oxidant (often molecular oxygen) at a cathode take place simultaneously. Conventional fuels such as hydrogen and methanol pose several storage and transportation problems, in particular, for portable fuel cells (e.g., for use with portable electric and electronic devices such as laptops, cell phones, and the like). Borohydride (and other metal hydride) based fuels, on the other hand, are of particular interest for portable fuel cells due, in particular, to their very high specific energy capacity. Examples of corresponding fuels are disclosed, e.g., in US 20010045364 A1, US 20030207160 A1, US 20030207157 A1, US 20030099876 A1, and U.S. Pat. Nos. 6,554,877 B2 and 6,562,497 B2, the disclosures of which are expressly incorporated by reference herein in their entireties. However, hydride-based fuels also pose problems, for example, undesired gas (hydrogen) evolution, which apparently is of particular concern in fuel cells which are to operate in a sealed condition (e.g., portable liquid fuel cells).

For example, the main oxidation reaction of the borohydride compound in a typical fuel comprising water, NaBH₄ and NaOH at the anode of a fuel cell can be represented as follows:

BH₄⁻+8OH⁻=BO₂⁻+6H₂O+8e⁻.

However, there also is a side reaction which leads to hydrogen evolution during the electrocatalytic oxidation:

BH₄⁻+4OH⁻=BO₂⁻+2H₂O+2H₂+4e⁻.

Moreover, usually there is also a spontaneous decomposition reaction of a borohydride compound:

BH₄⁻+2H₂O=BO₂⁻+4H₂.

The ratio of the desired oxidation reaction and the undesired side and decomposition reactions of the borohydride depends on many factors, inter alia, the current density, the temperature, the type of oxidation catalyst for the anode and the composition of the fuel.

Usually the fuel and electrolyte chambers of a fuel cell must be sealed hermetically in order to allow safe and comfortable use, transportation and storage of the fuel cell in any orientation thereof. The formation of hydrogen gas inside the fuel cell through, e.g., the above-described reactions, results in an increase in the pressure inside the fuel cell and thereby may cause substantial problems such as, e.g., destruction of the anode, changes in the electrical properties of the fuel cell and in some cases even an explosion of the fuel chamber. To avoid such problems and to ensure a safe operation, the fuel cell must be designed to permit the elimination (e.g., venting) of hydrogen gas (or any other gas present therein) even when the fuel cell is sealed in a liquid-tight manner. One possible way of doing this is to provide the casing of the fuel cell that contains, inter alia, the liquid fuel with one or more vents such as, e.g., one or more openings which are sealed by a gas-pervious material that is substantially impervious to liquids.

U.S. Patent Application Publication 200510158609 A1, the entire disclosure whereof is expressly incorporated by reference herein, discloses a fuel cell for use with a hydride-based fuel. The fuel cell comprises at least one opening for allowing hydrogen gas formed inside the fuel cell to escape therefrom. The opening is sealed by a membrane that is pervious to gas (e.g., hydrogen) and impervious to liquids and solids.

While gas-pervious and liquid-impervious openings solve the problem of undesired pressure build-up within the casing of the liquid fuel cell, they create a new problem, i.e., potential leakage of liquid from the casing of the fuel cell in the case of, e.g., accidental mechanical damage to the gas-pervious sealing structure (punctures, ruptures, etc.) or failure of the material due to flawed production methods, wear, etc. This problem is aggravated by the usually corrosive and/or aggressive nature of the liquids used inside the fuel cell (such as, e.g., the liquid fuel and/or the liquid electrolyte).

In view of the foregoing, it would be desirable to have available a fuel cell which is leak-proof even if any of the one or more gas-pervious openings in the casing of the fuel cell fails to prevent liquids inside the fuel cell from getting to the outside of the fuel cell.

### SUMMARY OF THE INVENTION

The present invention provides such a leak-proof fuel cell. The fuel cell comprises at least one liquid within a casing that comprises at least one opening which is sealed by a first structure that is gas-pervious and substantially impervious to the at least one liquid. At least that portion of the casing which comprises the at least one opening is enclosed by a second structure which allows gas to pass therethrough. A space defined by the casing and the second structure comprises therein at least one material that is capable of binding the at least one liquid that may leak from the casing (confining the at least one liquid to the space).

In one aspect of the fuel cell of the present invention, the fuel cell may be a portable fuel cell (including, for example, a fuel cell that is removably incorporated in a portable device such as, e.g., a laptop computer) and/or a direct liquid fuel cell. Further, the fuel cell may be refillable (i.e. to replenish spent fuel and/or electrolyte), in which case one or more cartridges may constitute a part of the fuel cell casing.

In another aspect, the at least one liquid may comprise a liquid fuel such as, e.g., a fuel comprising a borohydride compound, and/or it may comprise a liquid electrolyte such as, e.g., an alkaline solution, for example, an alkaline solution comprising an alkali metal hydroxide.

In yet another aspect, the casing may comprise an air-breathing cathode (e.g., the side of the air-breathing cathode that is opposite the side that faces the electrolyte chamber of the fuel cell forms a part of the outer surface of the casing).

In a still further aspect of the fuel cell of the present invention, the first structure may comprise a porous (e.g., microporous) material that is gas-pervious and substantially impervious to liquids.

In another aspect of the fuel cell, the casing thereof may comprise two or more openings (e.g., two, three, four, five, six, seven or eight openings).

In another aspect, at least a part of the second structure (e.g., substantially the entire second structure) may be made of a material that is gas-pervious and substantially impervious to liquids.

In yet another aspect, the second structure may be made of a material that is substantially impervious to gases and liquids, and the second structure may comprise at least one opening that is sealed by a third structure that is gas-pervious and substantially impervious to liquids. For example, the third structure may comprise a porous material (e.g., a porous material suitable for use in the first structure).

In another aspect of the fuel cell of the present invention, the at least one material that is capable of binding the at least one liquid may comprise a material that is capable of absorbing the at least one liquid. For example, this material may be present in a particulate form.

In one aspect, the material that is capable of absorbing the at least one liquid may comprise a superabsorbent and/or the material may be capable of absorbing liquids having a pH of about 7 and above.

In another aspect, the material that is capable of absorbing the at least one liquid may comprise a polymeric material. For example, the polymeric material may comprise a polymer that comprises at least one monomeric unit having an acidic functional group such as, e.g., a carboxylic acid group and/or a sulfonic acid group. By way of non-limiting example, the at least one monomeric unit may comprise a unit of an unsaturated carboxylic acid such as, e.g., acrylic acid and/or methacrylic acid. The polymeric material may, for example, comprise polyacrylic acid and/or a salt thereof (e.g., an alkali metal salt). In yet another aspect, the polymer may be at least partially crosslinked and/or at least partially neutralized.

In another aspect of the fuel cell of the present invention, the at least one material that is capable of binding the at least one liquid may comprise a spongy material. For example, the spongy material may be made of a material that is chemically resistant to liquids having a pH of about 7 and above.

The present invention also provides a leak-proof fuel cell which comprises at least one liquid within a casing that is substantially impervious to liquids and allows gas to pass therethrough, wherein at least that part of the casing which allows gas to pass therethrough is enclosed by a structure that is capable of substantially preventing liquid that has leaked from the casing to reach an outer surface of the structure.

In one aspect, the fuel cell may be portable and/or may be a direct liquid fuel cell. Further, the fuel cell may be refillable (i.e. to replenish spent fuel and/or electrolyte), in which case one or more cartridges may constitute a part of the fuel cell casing.

In another aspect, the at least one liquid may comprise a liquid fuel. For example, the liquid fuel may comprise a borohydride compound.

In yet another aspect of the fuel cell, the at least one liquid may comprise a liquid electrolyte. For example, the liquid electrolyte may comprise an alkaline solution. The alkaline solution may, for example, comprise water and/or NaOH and/or KOH.

In a still further aspect, the casing may comprise an air-breathing cathode therein.

In another aspect, the casing may comprise one or more openings that are sealed by a porous material that is gas-pervious and substantially impervious to liquids.

In another aspect of the fuel cell, the structure may be made of a material that is gas-pervious and substantially impervious to liquids. For example, the structure may comprise a plastic material. The plastic material may be flexible. By way of non-limiting example, the structure may comprise a bag-like structure.

In yet another aspect of the fuel cell, the structure may be made of a first material that is substantially impervious to gases and liquids and comprises at least one opening that is sealed by a second material that is gas-pervious and substantially impervious to liquids.

In another aspect, the fuel cell may further comprise at least one material that is capable of binding the at least one liquid and is disposed between the casing and the structure. For example, this material may be capable of absorbing the at least one liquid and may be a superabsorbent. The superabsorbent may comprise a polymer that comprises at least one monomeric unit having an acidic functional group such as a carboxylic acid group and/or a sulfonic acid group. In another aspect, the superabsorbent may comprise polyacrylic acid and/or a salt thereof.

In yet another aspect, the at least one material that is capable of binding the at least one liquid may comprise a spongy (e.g., foam) material.

In a still further aspect of the above fuel cell, the structure may comprise at least two portions, for example, an innermost portion which encloses at least that part of the casing which allows gas to pass therethrough, and an outermost portion which surrounds at least partially the innermost portion. The innermost portion may be gas-pervious and the outermost portion may be substantially impervious to liquids and may allow gas to pass therethrough.

In another aspect, the structure may further comprise at least one material that is capable of binding the at least one liquid and is disposed between the innermost portion and the outermost portion of the structure. This material may, for example, be capable of absorbing the at least one liquid such as, e.g., a superabsorbent. This superabsorbent may, for example, comprise polyacrylic acid and/or a salt thereof.

The present invention also provides a leak-proof fuel cell (e.g., a portable fuel cell) which comprises a liquid fuel and a liquid electrolyte within a casing that comprises at least one opening which is sealed by a first structure that is gas-pervious and substantially impervious to the liquid fuel and the liquid electrolyte. At least that portion of the casing which comprises the at least one opening is enclosed by a second structure which allows gas to pass therethrough. The space defined by the casing and the second structure comprises therein at least one material that is capable of absorbing the liquid fuel and the liquid electrolyte. The fuel cell may be a direct liquid fuel cell.

In one aspect of the fuel cell, the liquid fuel may comprise a borohydride compound and/or the liquid electrolyte may comprise an aqueous hydroxide solution.

In another aspect of the fuel cell, the casing may comprise an air-breathing cathode.

In a still further aspect, the first structure may comprise a porous material that is gas-pervious and substantially impervious to liquids. In another aspect, at least a part of the second structure may be made of a material that is gas-pervious and substantially impervious to liquids.

In another aspect of the fuel cell, the second structure may be made of a material that is substantially impervious to gases and liquids and the second structure may comprise at least one opening that is sealed by a third structure that is gas-pervious and substantially impervious to liquids.

In yet another aspect, the at least one material that is capable of absorbing the fuel and the electrolyte may comprise a superabsorbent and/or the material may be capable of absorbing liquids having a pH of about 7 and above. For example, the material may comprise polyacrylic acid and/or a salt thereof. Further, the material may be at least partially crosslinked.

The present invention also provides a fuel cell which comprises a casing having a cathode, an anode and at least one liquid enclosed therein. The casing comprises at least one opening sealed by a gas-pervious material and an enclosed space adjacent an outer surface of the casing has disposed therein at least one material that is capable of binding the at least one liquid.

The present invention further provides a method of leak-proofing a fuel cell which comprises at least one liquid within a casing that comprises in at least a part thereof a gas-pervious material. The method comprises enclosing at least that part of the casing which comprises the gas-pervious material with a gas-pervious structure to create an enclosed space between an outer surface of the casing and an inner surface of the structure and disposing within the space at least one material that is capable of substantially preventing liquid that has leaked from the casing to escape from the space.

In one aspect of the method, the at least one liquid may comprise a liquid fuel. For example, the liquid fuel may comprise a borohydride compound.

In another aspect, the at least one liquid may comprise a liquid electrolyte.

In yet another aspect of the method, the at least one material that is capable of substantially preventing liquid that has leaked from the casing to escape from the space may comprise a material that is capable of absorbing the at least one liquid. For example, the material may comprise a superabsorbent material such as, e.g., polyacrylic acid and/or a salt thereof.

The present invention also provides a method of leak-proofing a fuel cell which comprises at least one liquid within a casing that comprises in at least a part thereof a gas-pervious material. The method comprises disposing within an enclosed space adjacent an outer surface of the casing at least one material that is capable of binding the at least one liquid.

In one aspect, the at least one liquid may comprise a liquid fuel, for example a fuel that comprises a borohydride compound.

In another aspect, the at least one liquid may comprise a liquid electrolyte.

In yet another aspect of the method, the at least one material that is capable of binding the at least one liquid may comprise a material that is capable of absorbing the at least one liquid such as, e.g., a superabsorbent material. For example, the superabsorbent material may comprise polyacrylic acid and/or a salt thereof.

As set forth above, the present invention provides a leak-proof fuel cell. The type of the one or more liquids inside the casing of the fuel cell which also houses and/or incorporates the anode and the cathode depends on the fuel cell. If the fuel cell is a direct liquid fuel cell which uses a hydride such as a borohydride as the fuel, the one or more liquids will usually comprise at least a (preferably alkaline) aqueous solution and/or suspension of the borohydride compound such as, e.g., sodium borohydride. Of course, once the fuel cell has been partially or completely discharged, the liquid inside the casing will partly or exclusively comprise the oxidation product of the fuel. As set forth above, in the case of a borohydride fuel, the oxidation product of the borohydride compound is the corresponding borate compound.

The electrolyte inside the casing of the liquid fuel cell may be a liquid as well, for example, an aqueous solution of an alkali metal hydroxide such as NaOH and KOH. Accordingly, the liquid inside the casing of the fuel cell of the present invention will usually comprise at least a liquid fuel or at least a liquid electrolyte, or both a liquid fuel and a liquid electrolyte.

Those of skill in the art will appreciate that the present invention is not limited to fuel cells which comprise a hydride compound or a borohydride compound as component of a (liquid) fuel. Non-limiting examples of other liquid fuels that may be present inside the casing of the fuel cell of the present invention include fuels which comprise an alcohol such as, e.g., methanol, ethanol, (iso)propanol and mixtures thereof, glycols such as, e.g., ethylene glycol, propylene glycol and butylene glycol, carboxylic acids such as, e.g., formic acid, and liquid hydrocarbons such as pentane, hexane, gasoline, kerosene and diesel. Also, the liquid electrolyte, if present, may be different from an aqueous (alkaline or acidic) solution.

Those of skill in the art will also appreciate that it is sufficient for the fuel cell of the present invention to comprise a single liquid material inside the casing. The fuel will usually be liquid, wherefore the one or more liquids inside the casing of the fuel cell of the present invention will usually comprise a fuel. The electrolyte may also be present in liquid form. However, it is to be noted that the electrolyte may be any kind of electrolyte, including, by way of non-limiting example, solid or semi-solid materials such as, e.g., a gel electrolyte, a matrix electrolyte and a solid/polymer electrolyte.

The casing of the fuel cell of the present invention may be made of various materials. It will usually be impervious to gases and liquids and comprise openings which are sealed by a gas-pervious material to prevent a build-up of pressure inside the casing. Suitable casing materials include those that are non-brittle and resistant to the fuel, the oxidation product thereof, and to the electrolyte used. Non-limiting examples of suitable casing materials include organic polymers. Examples of preferred organic polymers include polyolefins such as, e.g., homo- and copolymers of ethylene and propylene (e.g., high density polyethylene), polysulfones, polyetheretherketones, homo- and copolymers of styrene, and mixtures of these polymers. To increase their chemical resistance to the liquids inside the casing, these materials may be partially or completely crosslinked. Of course, the casing may be made of two or more different materials (e.g., in different parts thereof). By way of non-limiting example, in a case where the fuel cell is refillable, the casing may comprise a fuel cartridge and/or an electrolyte cartridge as a part thereof. In this case, the material of the cartridge casing portion may be different from the material of the actual fuel cell casing portion.

The one or more gas-pervious openings comprised in the casing of the fuel cell of the present invention may be the same or different. As set forth above, these openings serve to prevent a pressure build-up (e.g., due to the generation of hydrogen) inside the casing. These openings are sealed by a gas-pervious material that is substantially impervious to liquids. However, as noted above, there is a risk that due to, e.g., accidental mechanical damage to the material or production-related failure of the material, the material becomes pervious to liquids, allowing liquids inside the casing to leak from the casing. Examples of gas-permeable materials for sealing the opening include porous (e.g., microporous) membrane materials which may be organic or inorganic or both and may be composite materials as well. Specific examples of such materials are set forth in, e.g., U.S. Patent Application Publication 2005/0158609 A1, mentioned above.

In one aspect of the fuel cell of the present invention, at least that part of the casing which comprises one or more openings that are sealed by a gas-pervious material (and preferably also that part that comprises the gas-breathing cathode, if present), is enclosed by a structure which is gas-pervious and gives rise to a free space that is defined by an outer surface of the casing and an inner surface of the structure. At least a part of this space will preferably have disposed therein one or more materials that are capable of substantially preventing liquid that leaks from the casing to escape from the space. These materials will usually be capable of binding (e.g., absorbing) the liquid to form a solid or semi-solid (e.g., gelled) matter or a highly viscous substance. Usually, the materials for binding the liquid will be solid or semi-solid (including gel-like), or at least highly viscous substances.

The structure may have one or more parts. It may have a shape, at least in a part thereof that is similar to or the same as the shape of the part of the casing that is enclosed thereby, but will have at least slightly larger dimensions than the enclosed part of the casing so that there is a free space between the casing and the structure. Of course, especially in cases where the structure encloses only a part of the casing, the structure may include a sealing material such as, e.g., a gasket, an O-ring and the like to completely seal the space between the structure and the casing. This seal is preferably liquid-tight, but may be porous to allow gas to pass therethrough, thereby optionally eliminating the need for any other means for allowing gas to escape from the space between the casing and the structure.

The material of the structure may be the same as or different from the material of the casing. Also, the structure may comprise different materials in different parts thereof. By way of non-limiting example, the material(s) of the structure may be substantially impervious to gases and liquids. In this case, the structure will usually have at least one opening that is sealed by a material that is gas-pervious. Examples of suitable gas-pervious materials include those that can be used for sealing the openings of the easing. Examples of other materials include those that may not be suitable for the openings of the casing because they would not be sufficiently resistant to a permanent chemical attack by the liquid fuel and/or the liquid electrolyte inside the casing. Non-limiting specific examples of materials that can be used as gas-pervious materials for the opening(s) of the enclosing structure include microporous membranes, e.g., those made of expanded PTFE, polypropylene etc.

The structure may also comprise or consist of a porous) material which is substantially liquid-impervious but gas-pervious. By way of non-limiting example, the material may comprise a composite material such as, e.g., a material made by compressing PTFE and polyolefin (e.g., polyethylene, polypropylene, etc.) powders, the powders having a particle size of up to about 0.5 μm.

Furthermore, the structure may be rigid or flexible, or may comprise both rigid and flexible parts. In one aspect, the structure or a part thereof may have the form of a liquid-impervious flexible bag (e.g., made of plastic) which encloses the casing and one or more materials that are capable of binding the leaking liquid(s). Especially if a first part of the structure is made of a material that may get easily damaged (e.g., punctured and/or ripped), it may be protected by a second part of the structure whose function may be to preserve the physical integrity of the first part of the structure.

The space between the casing and the structure will usually be occupied at least partially by one or more materials which are capable of substantially preventing liquid that has leaked from the casing (e.g., through an insufficiently sealed opening) to escape from the enclosed space even if the enclosed space is non completely liquid-tight. The materials can be arranged and optionally fixed within the enclosed space in any suitable way. By way of non-limiting example, in the case of a solid or semi-solid particulate material, the material may be used as such or enclosed in one or more sachets made of liquid-pervious material such as, e.g., paper, cloth, non-wovens, etc. It may also be fixed (e.g., glued) to an outer surface of the casing and/or an inner surface of the structure (e.g., by means of a double-sided tape). Further, it may be fixed (e.g., glued) to a web (e.g., of cloth, paper, non-wovens etc.), of which one or more sections may be disposed within the enclosed space. It may also be present in the form of a laminate and/or a sandwich structure in combination with other (preferably porous) materials which may or may not have absorbent properties. For example, the absorbent material may comprise a superabsorbent polymer mixed into a matrix material. The matrix material may, for example, comprise one or more materials selected from cellulose esters, acrylic acid esters, polyvinyl esters, copolymers of the foregoing and combinations thereof. Any combinations of these methods may also be advantageous. Of course, the methods set forth herein are but a few possible ways known to those of skill in the art of disposing a solid and, especially, a particulate material within the enclosed space.

Materials which can be used for substantially preventing liquid which leaks from the casing to escape from the enclosed space defined by an outer surface of the casing and an inner surface of the enclosing structure include materials which are capable of binding the liquid to form a solid or semi-solid (e.g., gel-like) substance or a highly viscous liquid. This binding can take place, e.g., by absorption, adsorption and/or chemical reaction between the material and the liquid. Preferably, the one or more materials include a material that is capable of absorbing the various liquids that may have leaked from the casing. Of course, in certain cases it may be desirable to use more than one material. For example, if there is more than one type of liquid inside the fuel cell and there is no material available that is capable of binding all of these types of liquids satisfactorily or equally well, respectively, the use of two or more materials may be indicated, each of which is capable of binding at least one of the different types of liquids satisfactorily and efficiently. This may, for example, be appropriate if there are two or more liquids within the casing and these liquids exhibit substantially different polarities and/or substantially different pH values. It is to be understood, however, that according to the present invention the simultaneous presence of two or more different materials is not limited to a particular situation.

Non-limiting examples of materials which can be used to absorb liquid that has leaked from the casing include spongy materials (e.g., those made of cellulose and derivatives thereof, etc.) and foam materials such as, e.g., polyurethane foam. These materials will usually show a substantial absorption capacity for the liquids that are present inside the casing. Also, they will preferably be resistant to chemical attack by any of these liquids at least to the extent that they will not react with these liquids to form harmful and/or liquid products. By way of non-limiting example, materials which find use in diapers, sanitary napkins, etc. may be advantageous for use in the present invention, provided they are sufficiently resistant to the liquids that may leak from the casing of a given fuel cell to not be destroyed by these liquids.

In a preferred aspect, the materials which can be used to absorb the one or more liquids that may have leaked from the casing include superabsorbents. Superabsorbents are materials which occupy a small volume in their dry state, but can absorb a volume of a liquid many times greater than the initial volume of the material (thus their name superabsorbents). Non-limiting specific examples of superabsorbent materials include (preferably crosslinked) polyacrylic acid and/or salts thereof (e.g., Na and K salts), polymethacrylic acid and/or salts thereof, polyvinyl alcohol, poly(2-hydroxyethyl methacrylate)/poly(ethylene oxide), isobutylene/maleic acid copolymers, poly(acrylamide) and polyvinylpyrrolidone.

Superabsorbent polymers suitable for use in the present invention include conventional superabsorbent polymers as that term is commonly used in the art. Specific examples of such materials include polymers of water soluble acrylic or vinyl monomers that are cross-linked with a polyfunctional reactant. Also included are starch modified polyacrylic acids and hydrolyzed polyacrylonitrile and their alkali metal salts. A more detailed discussion of superabsorbent polymers which may advantageously be used in the present invention is found in U.S. Pat. No. 4,990,541, the entire disclosure whereof is incorporated by reference herein.

A number of superabsorbent polymers are commercially available and these are also suitable for use in the present invention. Non-limiting examples of commercially available superabsorbent polymers include SANWET®, a starch grafted polyacrylate sodium salt; DRYTECH® 520 SUPERABSORBENT POLYMER available from Dow Chemical Co., Midland, Mich. (a superabsorbent derived from polypropenoic acid); AQUA KEEP manufactured by Seitetsu Kagaku Co., Ltd.; ARASORB® manufactured by Arakawa Chemical (USA) Inc.; ARIDALL® 1125 manufactured by Chemdall Corporation; and FAVOR® manufactured by Stockhausen, Inc.

Other non-limiting examples of materials which can be used to absorb the one or more liquids that may have leaked from the fuel cell casing include starch, cellulose and derivatives thereof such as, e.g. ethylcellulose, and particles of polyolefin microfibers and similar materials such as, e.g., those described in U.S. Pat. No. 5,029,699, the entire disclosure whereof is expressly incorporated by reference herein.

Further non-limiting examples of absorbent materials for use in the present invention comprise absorbent powders, such as starch graft copolymers which are commercially available as laminates on layer material such as tissue paper (such as, e.g., Waterlock® Laminates from Grain Processing Corp.). Fibrous absorbers, such as cotton known sold under the trademark Webril® may also be useful as absorbent materials for use in the present invention. Further examples of absorbent materials include cotton linters (e.g., those commercially available from Hercules Corp.), absorbent polymer based sheets (e.g., those commercially available from Pellon Co.) and filter papers such as those available from Whatman Co.

Additional non-limiting examples of absorbent materials for use in the present invention include those which are disclosed in JP 57-92032 and U.S. Pat. Nos. 4,725,428, 4,725,629, 4,076,663, 4,454,268, 4,337,181 4,133,784, 3,669,103, 4,640,874, 6,040,088, 6,986,969, 4,563,404, 4,435,488, 4,585,710, 5,433,994, 6,932,846, 6,492,062, 6,294,287 and 5,206,096, the entire disclosures whereof are incorporated by reference herein. In these documents, the absorbent materials are sometimes (also) referred to as “gelling materials”.

The choice of binding material such as, e.g., superabsorbent will depend, at least to some extent, on the pH of the liquid that is to be absorbed or otherwise bonded. For example, if the liquid(s) inside the casing is (are) alkaline, the material should be capable of binding (e.g., absorbing) alkaline liquids. Conversely, if the liquid(s) inside the casing is (are) acidic, the material should be capable of binding (e.g., absorbing) acidic liquids. Alternatively, if the material is not per se suitable for binding the liquid(s) inside the casing, it may be mixed with a substance that is capable of converting the liquid(s) into liquid(s) that the material can bind. By way of non-limiting example, if the liquid(s) inside the fuel cell is (are) acidic, a binding material which is incapable or insufficiently capable of binding acidic liquids but capable of binding neutral or alkaline liquids may be mixed with a base such as, e.g. NaOH, in an amount which will convert the acidic liquids into alkaline (or at least neutral) liquids.

The amount of the one or more binding materials such as, e.g., superabsorbents, within the enclosed space adjacent the outer surface of the casing will usually be sufficient to absorb or otherwise bind at least about 10%, e.g., at least about 20%, or at least about 30% of the total volume of liquids (liquid fuel and/or liquid electrolyte) contained inside the casing. Preferably, the amount will be sufficient to absorb substantially all or at least a major percentage (e.g., at least about 70%, at least about 80%, or at least about 90%) of the total volume of liquids inside the casing. The absorbent binding materials may show a considerable increase in volume upon binding (absorbing) the leaking liquid. Accordingly, sufficient space needs to be provided for the materials to expand (e.g., swell), because these materials may not be able to show the desired (and expected) liquid binding capacity if there is not enough space or volume for them to expand during the absorption process.

In one aspect of the fuel cell of the present invention, the structure that is used to enclose a potential leakage area of the casing (or the entire casing) may comprise at least two parts or portions, for example, an innermost portion which encloses at least the one or more parts of the casing which allow gas to pass therethrough, and an outermost portion which surrounds the innermost portion. The innermost portion may be gas-pervious and the outermost portion may be substantially impervious to liquids and may allow gas to pass therethrough. By way of non-limiting example, the innermost portion may comprise an optionally flexible material that is pervious to gases and liquids but impervious to solids (such as, e.g., paper or the like) and the outermost portion may be impervious to liquids and pervious to gases (e.g., due to the material it is made from as such or due to one or more gas-pervious sealed openings provided therein). The one or more materials that are capable of binding leaked liquid(s) may be disposed within the space defined by the innermost portion and the outermost portion. Regarding exemplary ways of disposing the one or more materials within the space, reference may be made to the ways discussed above in the context of a one-part structure.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross section view of a non-limiting embodiment of a fuel cell of the present invention;

FIG. 2 shows a cross section view of another non-limiting embodiment of a fuel cell of the present invention;

FIG. 3 shows a cross section view of yet another non-limiting embodiment of a fuel cell of the present invention; and

FIG. 4 shows a cross section view of a still further non-limiting embodiment of a fuel cell of the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description making apparent to those skilled in the art how the several forms of the present invention may be embodied in practice.

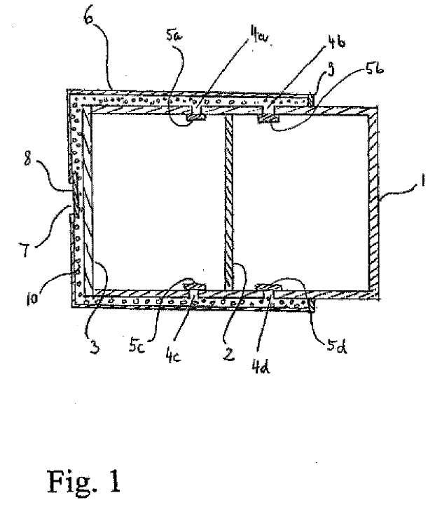

By way of one non-limiting example, FIG. 1 shows a schematic cross section of a leak-proof fuel cell of the present invention wherein some parts which are of no significance in the context of the present invention have been omitted in order to reduce complexity. The casing 1 of the fuel cell houses an anode 2 and has an air-breathing cathode 3 at one side thereof. The space between cathode 3 and anode 2 will usually contain electrolyte. The other space will usually be filled with fuel. The casing 1 has four openings 4a-4d, each of which is sealed by a gas-pervious but liquid-impervious membrane 5a-5d (e.g., a microporous membrane). The part of casing 1 that comprises the openings 4a-4d and air-breathing cathode 3 is enclosed by a structure 6 of liquid- and gas-impervious material and a gasket or O-ring 9. Structure 6 has an opening 7 which is sealed by a gas-pervious but liquid-impervious membrane 8 (e.g., a microporous membrane) which may be of the same material as the membranes 5 or may be of a different material. In this regard, it is to be appreciated that the material for membrane 8 is not subject to the same demanding requirements as the material for the membranes 5a-d (for example, it does not have to be able to withstand an aggressive liquid for long periods of time), wherefore the former material may show a lower degree of sophistication and/or quality than the latter material. The space between casing 1 and structure 6 is partially filled with a liquid-binding material 10 such as, e.g., a superabsorbent. As indicated above, a particulate material 10 may be attached to an outer surface of casing 1 and/or an inner surface of structure 6 and/or may be disposed in the form one or more sachets filled with the material and/or may be attached to sections of web material, to name but a few possible ways of disposing material 10 within the space defined by casing 1 and structure 6. Any liquid that leaks through the openings 4a-4d (and membranes 5a-5d, respectively) and/or air-breathing cathode 3 into the space between casing 1 and structure 6 will come into contact with material 10 and will be (preferably substantially completely) bound (e.g., absorbed) thereby. Accordingly, even if the space between casing 1 and structure 6 is not sealed in a completely liquid-tight manner, no or substantially no liquid from the inside of casing 1 will be able to get beyond structure 6.

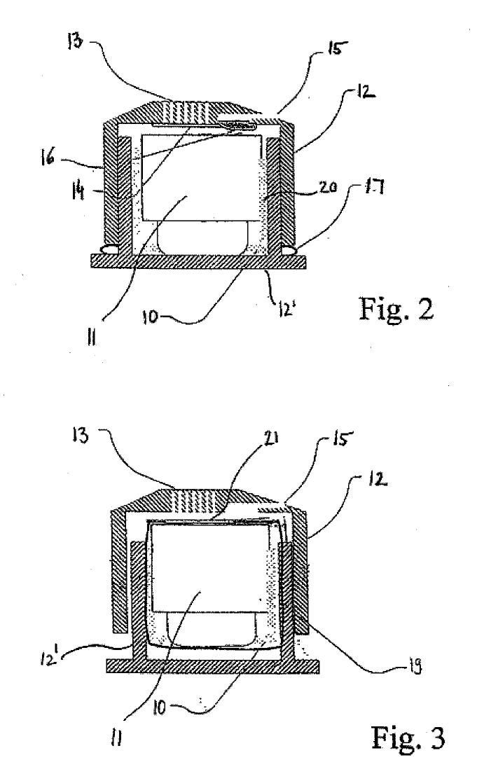

FIG. 2 shows a cross section view of another non-limiting embodiment of a fuel cell of the present invention. FIG. 2 does not show the inside of casing 11 for the sake of simplicity. FIG. 2 shows a casing 11 which is enclosed by a two-part structure with an outer part 12 and an inner part 12′ which are slidably movable with respect to each other. O-ring or gasket 17 seals the space between outer part 12 and inner part 12′ of the structure. Casing 11 of the fuel cell has a gas-pervious section which is represented at 20. The outer part 12 of the structure has several openings 13 which are sealed by a gas-pervious membrane 14 which may be of the same material as membrane 8 in the embodiment of FIG. 1. Additionally, outer part 12 of the structure also comprises an opening 15 for an electrical connection between the fuel cell and a device that is to be charged by the fuel cell. Opening 15 is sealed by a material 16 which will usually be impervious to gases and liquids. The space between casing 11 and inner and outer parts 12′ and 12 of the sealing structure is filled with a binding (e.g., absorbing) material 10 which may be the same as in the case of FIG. 1. Any liquid that leaks through gas-pervious section 20 of casing 11 into the space between casing 11 and structure 12/12′ will come into contact with material 10 and be substantially completely bound (e.g., absorbed) thereby. Accordingly, even if the space between casing 11 and structure 12/12′ is not sealed in a completely liquid-tight manner, no or substantially no liquid from the inside of casing 11 will be able to get beyond structure 12/12′.

FIG. 3 shows a cross section view of yet another non-limiting embodiment of a fuel cell of the present invention. FIG. 3 does not show the inside of the casing 11 for the sake of simplicity. FIG. 3 shows a casing 11 which is enclosed by an outer enclosing structure with an outer part 12 and an inner part 12′ which are slidably movable with respect to each other, and an inner enclosing structure 19 which is surrounded by outer structure 12/12′ and completely encloses casing 11 of the fuel cell. Casing 11 comprises a gas-pervious section which is represented at 20. Inner structure 19 is in the form of a flexible bag of gas- and liquid-impervious material, which bag comprises therein a membrane 21 of a gas-pervious material that is substantially impervious to liquids. Of course, structure 19 itself may be made of a gas-pervious material, in which case membrane 21 may be dispensed with. Outer part 12 of the outer structure has several openings 13. In contrast to the corresponding part of the embodiment of FIG. 2, the openings 13 do not have to be sealed because sealing is provided by inner structure 19. For the same reason, opening 15 (for an electrical connection between the fuel cell and a device that is to be charged by the fuel cell) of outer part 12 of the outer structure, does not require sealing, either. The space between casing 11 and inner structure 19 contains a binding (e.g., absorbing) material) 10 which may be the same as in the case of FIG. 2. Any liquid that leaks through gas-pervious section 20 of casing 11 into the space between casing 11 and structure 12/12′ will come into contact with material 10 and be substantially completely bound (e.g., absorbed) thereby. Accordingly, even if the space between casing 11 and inner structure 19 is not sealed in a completely liquid-tight manner, no or substantially no liquid from the inside of casing 11 will be able to get beyond structure 19, or at least beyond outer structure 12/12′.

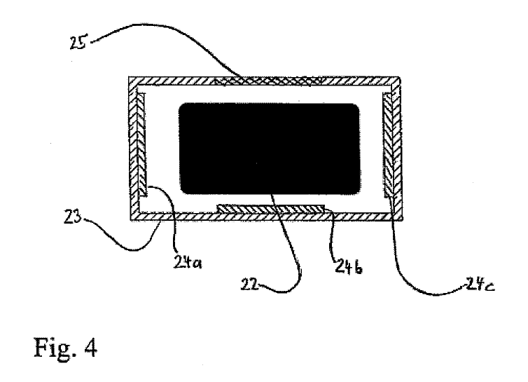

FIG. 4 shows a schematic cross section view of a still further non-limiting embodiment of a fuel cell of the present invention. FIG. 4 does not show the inside of casing 22 or any gas-pervious section of the casing 22 in order to reduce complexity. FIG. 4 shows a casing 22 which is completely enclosed by a sealing structure 23 (for example, a one-part structure). Structure 23 comprises a part or section 25 which is made of a material which is substantially impervious to liquids but allows gases to pass therethrough. For example, section 25 may comprise a gas-pervious membrane which may be made of the same material as membrane 8 in the embodiment of FIG. 1. The space between casing 22 and sealing structure 23 comprises a binding (e.g., absorbing) material which may be the same as in the case of FIG. 1 and is shown in FIG. 4 to be mounted (e.g., by means of an adhesive tape or the like) in locations 24a-24c on the inner surface of the sealing structure 23. Any liquid that leaks through a gas-pervious section of casing 22 into the space between casing 22 and structure 23 will come into contact with binding material in locations 24a-24c and be substantially completely bound (e.g., absorbed) thereby. Accordingly, even if the space between casing 22 and structure 23 is not sealed in a completely liquid-tight manner, no or substantially no liquid from the inside of casing 22 will be able to reach the outside of structure 23.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A leak-proof fuel cell, wherein the fuel cell comprises at least one liquid within a casing that comprises at least one opening which is sealed by a first structure that is gas-pervious and substantially impervious to the at least one liquid, at least that portion of the casing which comprises the at least one opening being enclosed by a second structure which allows gas to pass therethrough, a space defined by the casing and the second structure comprising therein at least one material that is capable of binding the at least one liquid.

2. The fuel cell of claim 1, wherein the fuel cell is a portable fuel cell.

3. The fuel cell of any one of claim 1, wherein the fuel cell is a direct liquid fuel cell.

4. The fuel cell of claim 1, wherein the at least one liquid comprises a liquid fuel.

5. The fuel cell of claim 4, wherein the liquid fuel comprises at least one of a hydride compound and a borohydride compound.

6. The fuel cell of claim 1, wherein the at least one liquid comprises a liquid electrolyte.

7. The fuel cell of claim 6, wherein the liquid electrolyte comprises an aqueous solution.

8. The fuel cell of claim 7, wherein the aqueous solution comprises an alkali metal hydroxide.

9. The fuel cell of claim 1, wherein the first structure comprises a porous material that is gas-pervious and substantially impervious to liquids.

10. The fuel cell of claim 9, wherein at least a part of the second structure comprises a material that is gas-pervious and substantially impervious to liquids.

11. The fuel cell of claim 1, wherein the second structure is made of a material that is substantially impervious to gases and liquids and wherein the second structure comprises at least one opening that is sealed by a third structure that is gas-pervious and substantially impervious to liquids.

12. The fuel cell of claim 11, wherein the third structure comprises a porous material.

13. The fuel cell of claim 1, wherein the at least one material that is capable of binding the at least one liquid comprises a material that is capable of absorbing the at least one liquid.

14. The fuel cell of claim 13, wherein the material that is capable of absorbing the at least one liquid is present in a particulate form.

15. The fuel cell of claim 13, wherein the material that is capable of absorbing the at least one liquid comprises a superabsorbent.

16. The fuel cell of claim 13, wherein the material is capable of absorbing liquids having a pH of about 7 and above.

17. The fuel cell of claim 13, wherein the material that is capable of absorbing the at least one liquid comprises a polymeric material.

18. The fuel cell of claim 17, wherein the polymeric material comprises a polymer that comprises at least one monomeric unit having an acidic functionality.

19. The fuel cell of claim 18, wherein the acidic functionality comprises at least one of a carboxylic acid group and a sulfonic acid group.

20. The fuel cell of claim 18, wherein the at least one monomeric unit having an acidic functionality therein comprises a unit of an unsaturated carboxylic acid.

21. The fuel cell of claim 18, wherein the polymeric material comprises at least one of polyacrylic acid and a salt thereof.

22. The fuel cell of claim 18, wherein the polymer is at least partially crosslinked.

23. The fuel cell of claim 22, wherein the polymer is at least partially neutralized.

24. The fuel cell of claim 1, wherein the at least one material that is capable of binding the at least one liquid comprises a spongy material.

25. A leak-proof fuel cell, wherein the fuel cell comprises at least one liquid within a casing that is substantially impervious to liquids and allows gas to pass therethrough, at least that part of the casing which allows gas to pass therethrough being enclosed by a structure that is capable of substantially preventing liquid that has leaked from the casing to reach an outer surface of the structure.

26. The fuel cell of claim 25, wherein the at least one liquid comprises a liquid fuel.

27. The fuel cell of claim 25, wherein the casing comprises a plurality of openings which are sealed by one or more gas-pervious materials that are substantially impervious to the at least one liquid.

28. The fuel cell of claim 25, wherein the structure is made of a material that is gas-pervious and substantially impervious to liquids

29. The fuel cell of claim 25, wherein the structure comprises a plastic material.

30. The fuel cell of claim 29, wherein the plastic material is flexible.

31. The fuel cell of claim 25, wherein the structure comprises a bag structure.

32. The fuel cell of claim 25, wherein the structure is made of a first material that is substantially impervious to gases and liquids and comprises at least one opening that is sealed by a second material that is gas-pervious and substantially impervious to liquids.

33. The fuel cell of claim 25, wherein the fuel cell further comprises at least one material that is capable of binding the at least one liquid and is disposed between the casing and the structure.

34. The fuel cell of claim 33, wherein the at least one material that is capable of binding the at least one liquid comprises a material that is capable of absorbing the at least one liquid.

35. The fuel cell of claim 25, wherein the structure comprises at least two portions.

36. The fuel cell of claim 35, wherein the structure comprises an innermost portion which encloses at least that part of the casing which allows gas to pass therethrough, and an outermost portion which surrounds at least partially the innermost portion.

37. The fuel cell of claim 36, wherein the innermost portion is gas-pervious and the outermost portion is substantially impervious to liquids and allows gas to pass therethrough.

38. The fuel cell of claim 36, wherein the structure further comprises at least one material that is capable of binding the at least one liquid and is disposed between the innermost portion and the outermost portion of the structure.

39. A leak-proof fuel cell, wherein the fuel cell comprises a liquid fuel and a liquid electrolyte within a casing that comprises at least one opening which is sealed by a first structure that is gas-pervious and substantially impervious to the liquid fuel and the liquid electrolyte, at least that portion of the casing which comprises the at least one opening being enclosed by a second structure which allows gas to pass therethrough, a space defined by the casing and the second structure comprising therein at least one material that is capable of absorbing the liquid fuel and the liquid electrolyte.

40. The fuel cell of claim 39, wherein the liquid fuel comprises a borohydride compound.

41. The fuel cell claim 40, wherein the liquid electrolyte comprises a hydroxide solution.

42. The fuel cell of claim 41, wherein the first structure comprises a porous material that is gas-pervious and substantially impervious to liquids.

43. The fuel cell of claim 42, wherein at least a part of the second structure comprises a material that is gas-pervious and substantially impervious to liquids.

44. The fuel cell of claim 39, wherein the second structure is made of a material that is substantially impervious to gases and liquids and wherein the second structure comprises at least one opening that is sealed by a third structure that is gas-pervious and substantially impervious to liquids.

45. A fuel cell which comprises a casing having a cathode, an anode and at least one liquid enclosed therein, wherein the casing comprises at least one opening sealed by a gas-pervious material and wherein an enclosed space adjacent an outer surface of the casing has disposed therein at least one material that is capable of binding the at least one liquid.

46. A method of leak-proofing a fuel cell which comprises at least one liquid within a casing that comprises in at least a part thereof a gas-pervious material, wherein the method comprises enclosing at least that part of the casing which comprises the gas-pervious material with a gas-pervious structure to create an enclosed space between an outer surface of the casing and an inner surface of the structure and disposing within the space at least one material that is capable of substantially preventing liquid that has leaked from the casing to escape from the space.

47. The method of claim 46, wherein the at least one liquid comprises a liquid fuel.

48. The method of claim 47, wherein the at least one material that is capable of substantially preventing liquid that has leaked from the casing to escape from the space comprises a material that is capable of absorbing the at least one liquid.

49. A method of leak-proofing a fuel cell which comprises at least one liquid within a casing that comprises in at least a part thereof a gas-pervious material, wherein the method comprises disposing within an enclosed space adjacent an outer surface of the casing at least one material that is capable of binding the at least one liquid.
